(19) United States
(12) Patent Application Publication
(10) Pub. No.: US 2008/0019412 A1
(43) Pub. Date: Jan. 24, 2008

(54) Laser beam injecting optical device for optical fiber

(75) Inventor: Makoto Ishibashi, Nasushiobara-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); Toshiba Electron Tubes & Devices Co., Ltd., Otawara-shi (JP)

(21) Appl. No.: 11/826,895

(22) Filed: Jul. 19, 2007

(30) Foreign Application Priority Data
Jul. 19, 2006 (JP) 2006-196715

(51) Int. Cl. H01S 3/08

(52) U.S. Cl. 372/101

(57) ABSTRACT

In a shielding case, a condenser lens condenses a laser beam output by a laser oscillator to inject the laser beam into an entrance end face of an optical fiber disposed posterior to a focusing point of the laser beam. Ventilation of an ambient gas in the shielding case is carried out by ventilating means, and the ambient gas bringing about ionization in the vicinity of the focusing point of the laser beam is eliminated, thereby preventing the outbreak of air breakdown.

### CROSS-REFERENCE TO RELATED APPLICATIONS

This application is based upon and claims the benefit of priority from prior Japanese Patent Application No. 2006-196715, filed Jul. 19, 2006, the entire contents of which are incorporated herein by reference.

### BACKGROUND OF THE INVENTION

1. Field of the Invention

The present invention relates to a laser beam injecting optical device for optical fiber, which injects a laser beam into an optical fiber.

2. Description of the Related Art

Conventionally, in the fields of, for example, laser ablation, laser induced fluorescence analysis, laser peening, and the like, a laser beam, whose peak power is mage greater than or equal to 1 MW, obtained by a giant-pulse oscillation method, has been used.

A step-index optical fiber made of a material containing quartz and having a core diameter of about 1 mm is used for the transmission of such a high-power laser beam, and any continuous oscillation light up to several kW can be transmitted through one optical fiber. However, when the pulse energy of a short pulse laser whose pulse width is about several nsec is greater than or equal to several dozen mJ, the peak power thereof is greater than or equal to several MW. Namely, because the peak power is greater by three figures or more than a continuous oscillation light, when a laser beam is injected into an optical fiber, the peak power density is made to be 10⁻¹ to GW/cm² order, which is extremely high. Therefore, damage due to an avalanche of electrons or multiphoton absorption is brought about, which instantly breaks the optical fiber, making it difficult to transmit a laser beam (for example, refer to “Laser Handbook”, written by The Laser Society of Japan, Ohmsha Ltd., p463 and p473). Therefore, a continuous oscillation light is mainly used for laser beam transmission through an optical fiber, and a short pulse laser beam having peak power of several MW or more is unsuitable for transmission through an optical fiber.

In a conventional and general injection system, a laser beam emitted from a laser oscillator is injected into an optical fiber via an injection lens. At this time, a laser beam is focused on the optical fiber with an entrance aperture which is less than the core diameter in order to take spatial matching of the laser beam with a core diameter of an entrance end face of the optical fiber, and so as not to exceed an entrance NA (Numerical Aperture) of the optical fiber (for example, refer to “Laser Processing Technology” written by Hiromichi Kawasumi, NIKKAN KOGYO SHIMBUN LTD., p34 to p37).

There has been reported that a threshold value of damage due to pulse laser beam of a quartz glass material is about 100 GW/cm² with a pulse width of about 5 nsec (for example, refer to “Laser Handbook” written by The Laser Society of Japan, Ohmsha Ltd., p463 and p473). However, the practical limit of a laser beam having distributions spatially and temporarily with respect to an optical fiber is much lower than that. In a conventional injection method, when an Nd:YAG laser beam of 10 Hz with a pulse width of 5 nsec, whose oscillation is repeated is injected into an optical fiber whose core diameter is φ1 mm, damage is brought about particularly inside the optical fiber at pulse energy of about 30 to 40 mJ, i.e., at peak power of 6 to 8 MW (0.76 to 1.0 GW/cm² as the peak power density with respect to the core diameter of φ1 mm), which makes it impossible to carry out transmission of a laser beam of 10 MW or more.

Then, as a means for avoiding damage to an optical fiber, there is a method in which a focusing point of a laser beam by a condenser lens is formed anterior to the optical fiber, and a scattered laser beam is injected into the optical fiber, thereby preventing the optical fiber from being damaged due to focusing on an entrance end face and the inside of the optical fiber (refer to, for example, Jpn. Pat. Appln. KOKAI Publication No. 2005-242292 (on the fifth page, FIG. 1)).

However, in the structure in which a focusing point of a laser beam by a condenser lens is formed anterior to the optical fiber in order to avoid the damage on an entrance end face and at the inside of the optical fiber, when a pulse laser beam whose peak power is greater than or equal to several MW is condensed by a condenser lens to be injected into an optical fiber whose core diameter is about φ1 mm, laser beam transmission is possible immediately after starting oscillation of the laser beam. However, the air in the vicinity of the focusing point of the laser beam by the condenser lens comes into an ionization state gradually as time elapses. Therefore, air breakdown is frequently brought about, which brings about the problem that stable laser beam transmission is impossible under the influence of plasma generated by the air breakdown.

### BRIEF SUMMARY OF THE INVENTION

The present invention has been achieved in consideration of the circumstances, and an object of the invention is to provide a laser beam injecting optical device for optical fiber, which is capable of carrying out stable laser beam transmission through an optical fiber by preventing the outbreak of air breakdown due to ionization of an ambient gas in the vicinity of a focusing point of a laser beam by a condenser lens.

A laser beam injecting optical device for optical fiber according to the invention comprises: a shielding case; a laser oscillator which outputs a laser beam into the shielding case; a condenser lens which is disposed in the shielding case, and condenses a laser beam output by the laser oscillator; an optical fiber positioning mechanism which disposes an entrance end face of the optical fiber posterior to a focusing point of the laser beam by the condenser lens in the shielding case, and makes the laser beam diffusive to be injected into the entrance end face of the optical fiber; and ventilating means for ventilating an ambient gas in the shielding case.

According to the present invention, a laser beam output from a laser oscillator is condensed by a condenser lens in a shielding case, and the laser beam is injected in a diffusive manner into an entrance end face of an optical fiber disposed posterior to a focusing point of the laser beam by the condenser lens. Moreover, an ambient gas in the shielding case is ventilated by ventilating means. As a result, the ambient gas is changed by eliminating the ambient gas bringing about ionization in the vicinity of the focusing point of the laser beam by the condenser lens, thereby preventing the outbreak of air breakdown and enabling stable laser beam transmission through an optical fiber.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a structural diagram of a laser beam injecting optical device for optical fiber showing one embodiment of the present invention;

FIG. 2 is a structural diagram in which a laser beam injection adjusting device is applied to the laser beam injecting optical device for optical fiber; and

FIG. 3 is a structural diagram of a laser induced fluorescence analyzing apparatus to which the laser beam injecting optical device for optical fiber is applied.

### DETAILED DESCRIPTION OF THE INVENTION

Hereinafter, one embodiment of the present invention will be described with reference to the drawings.

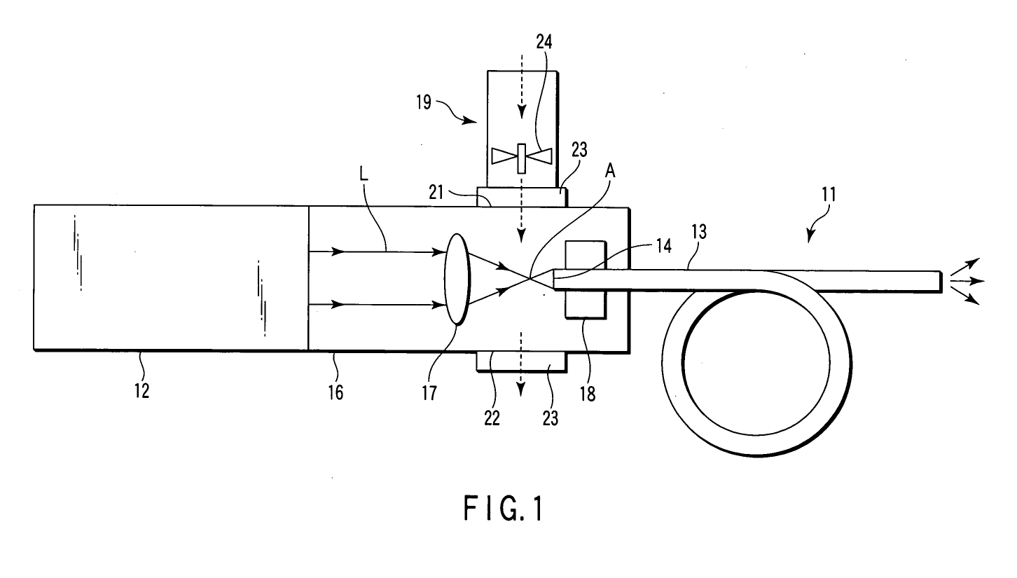

As shown in FIG. 1, a laser beam injecting optical device for optical fiber 11 is for injecting a laser beam L whose peak power is about 1 MW to 25 MW, serving as a pulse laser beam generated by a laser oscillator 12 serving as a solid-state laser oscillator in a giant-pulse oscillation method, into an entrance end face 14 of an optical fiber 13 with a predetermined core diameter and clad thickness without damaging the optical fiber 13. Further, the laser beam injecting optical device for optical fiber 11 is for making it possible to carry out stable laser beam transmission through the optical fiber 13. Note that, because there is a risk that the optical fiber 13 whose core diameter is about φ1 mm is broken when the peak power of the laser beam L is greater than 25 MW, the peak power is preferably less than or equal to 25 MW.

The laser beam injecting optical device for optical fiber 11 has a shielding case 16, and the laser oscillator 12 outputting the laser beam L into the shielding case 16 is disposed at one end of the shielding case 16. A condenser lens 17 condensing the laser beam L output from the laser oscillator 12 is disposed inside the shielding case 16. An optical fiber positioning mechanism 18 adjusting a positional relationship between the condenser lens 17 and the entrance end face 14 of the optical fiber 13 is disposed at the other end of the shielding case 16. Further, ventilating means 19 for exchanging an ambient gas in the shielding case 16 is disposed at the shielding case 16.

It is only necessary that the shielding case 16 is structured to prevent dust and the like from entering the shielding case 16 from outside.

The condenser lens 17 is not particularly limited as long as the condenser lens 17 is a convex lens and has a material and a shape resistant to heat generated due to the laser beam L emitted from the laser oscillator 12 being injected. Note that the condenser lens 17 may, as needed, be a synthetic lens in which two thin lenses are fitted together.

The optical fiber positioning mechanism 18 has, for example, an XYZ stage which holds an end of the optical fiber 13 in the shielding case 16, carries out an adjustment in which the central axis of the entrance end face 14 of the optical fiber 13 is aligned with an optical axis of the laser beam L condensed by the condenser lens 17, and adjusts an interval at which the condenser lens 17 and the entrance end face 14 of the optical fiber 13 face one another.

The optical fiber 13 is adjusted by the optical fiber positioning mechanism 18 such that the entrance end face 14 of the optical fiber 13 is positioned at a position away by a predetermined distance posterior to a focal point position, i.e. a focusing point A of the laser beam L by the condenser lens 17. Note that the optical fiber positioning mechanism 18 can be arbitrarily adjusted by hand, a locomotive mechanism such as a motor and a gear mechanism, or the like.

Note that the entrance end face 14 of the optical fiber 13 is positioned at a position away by a predetermined distance posterior to a focal point position, i.e. the focusing point A of the condenser lens 17, with the result that the laser beam L injected into the entrance end face 14 of the optical fiber 13 is made diffusive. Namely, provided that the laser beam L injected into the entrance end face 14 of the optical fiber 13 is made diffusive by optimizing a distance between the entrance end face 14 of the optical fiber 13 and the condenser lens 17, the laser beam L injected into the optical fiber 13 converges at a specific position in the optical fiber 13, and as a result, the peak power density at the specific position in the optical fiber 13 is made higher, thereby preventing the optical fiber 13 from being damaged.

The ventilating means 19 has an inlet 21 for guiding an ambient gas into the shielding case 16, and an exhaust port 22 for exhausting the ambient gas from the shielding case 16. These inlet 21 and exhaust port 22 are provided to face one another with the focusing point A of the laser beam L by the condenser lens 17 interposed therebetween. Dustproof filters 23 such as HEPA (High Efficiency Particulate Air Filter) filters are disposed at to the inlet 21 and the exhaust port 22. A fan 24 for feeding an ambient gas into the shielding case 16 is disposed at the inlet 21. As the ambient gas, in addition to air, a gas other than air may be used.

Meanwhile, it is necessary to inject the laser beam L into the optical fiber 13 at an appropriate entrance NA. When the entrance NA is too small, it is impossible to suppress the convergence of the laser beam L inside the optical fiber 13.

When the entrance NA is great, on the other hand, an outgoing angle of the optical fiber 13 is made too great, which brings about the problem that an irradiating optical system is made greater at the time of irradiating an outgoing light onto a target object. This is because the entrance NA must be less than or equal to about 0.25 rad in order to form an image, by one plane-convex lens, of the outlet of the optical fiber 13 on a target object at an imaging magnification less than or equal to 1 by using a glass material with a refractive index of about 1.5.

Further, when the entrance NA is high, a difference in the refractive index between a clad and a core is made greater, which brings about the problem that the mechanical strength deteriorates, and the clad is made fragile and frangible. This is because, given that a refractive index of the core is n1 and a refractive index of the clad is n2, the relation of NA=√(n1)²−(n2)²] is established, and it is necessary to lower the refractive index of the clad in order to make the entrance NA greater, and therefore, it is necessary to increase the amounts of fluorine and boron doped on the clad material.

Therefore, in order to shorten the total length of the optical fiber injection optical system, and to inject the light at about 0.06 to 0.22 rad serving as an appropriate entrance NA, it is necessary to use the condenser lens 17 with a relatively short focal length less than or equal to about 50 mm.

Further, in the case where the focusing point A of the laser beam L is positioned anterior to the optical fiber 13, a large quantity of dirt and dust in an ambient gas, if any, evaporates at the focusing point A to make it impossible to carry out stable transmission. Then, an optical fiber injection system including an optical path space from the condenser lens 17 to the optical fiber 13 is disposed in the shielding case 16, which makes it possible to shield the optical fiber injection system from the dust.

Further, when the condenser lens 17 with a short focal distance is used, a focused diameter of the laser beam L is made as small as about several dozen μm to 100 μm order. Therefore, a power density is about 100 to 200 GW/cm² which is a threshold value at which air breakdown occurs. Then, stable laser beam transmission is possible immediately after starting laser oscillation. However, the ambient gas in the vicinity of the focusing point A of the laser beam L by the condenser lens 17 comes into an ionization state gradually as time elapsed, which frequently brings about air breakdown, and it becomes impossible to carry out stable laser beam transmission under the influence of plasma generated by the air breakdown.

Therefore, by operating the fan 24 of the ventilating means 19, a new ambient gas is guided into the shielding case 16 from the inlet 21 of the shielding case 16, and the ambient gas in the shielding case 16 is exhausted from the exhaust port 22 of the shielding case 16, thereby exchanging the ambient gas in the shielding case 16. Therefore, the ambient gas on the brink of ionization brought about in the vicinity of the focusing point A of the laser beam L is exhausted, and it is possible to prevent the outbreak of air breakdown, making it possible to carry out stable laser beam transmission by the optical fiber 13.

In particular, because the inlet 21 and the exhaust port 22 are provided so as to face one another with the focusing point A of the laser beam L by the condenser lens 17 interposed therebetween, the ambient gas flows through the position of the focusing point A of the laser beam L by the condenser lens 17, which makes it possible to reliably exchange the ambient gas.

Moreover, it is necessary to prevent dust from being mixed in at the time of exchanging the ambient gases. Then, by disposing the dustproof filter 23 at the inlet 21, it is possible to increase the cleanliness of the ambient gas to be guided into the shielding case 16. Further, by disposing the dustproof filter 23 at the exhaust port 22 as well, it is possible to prevent dust from invading during a time in which the ventilating means 19 is being stopped.

Next, a specific embodiment of the laser beam injecting optical device for optical fiber 11 will be shown.

By using an Nd:YAG laser by a giant-pulse oscillation method as the laser oscillator 12, a plane-convex lens with f=40 mm as the condenser lens 17, a step-index quartz material optical fiber as the optical fiber 13, and HEPA filters as the dustproof filters 23, the Nd:YAG laser beam by a giant-pulse oscillation method, in which a laser pulse width is 5 nsec, pulse energy is 100 mJ (peak power is 22 MW=110 mJ/5 nsec), and a beam aperture is 6 mm, has been injected at an entrance NA of 0.08 rad so as to position the focusing point A by 5 mm anterior to the entrance end face 14 of the optical fiber 13. As a result, the fiber emission energy of 100 mJ has been acquired.

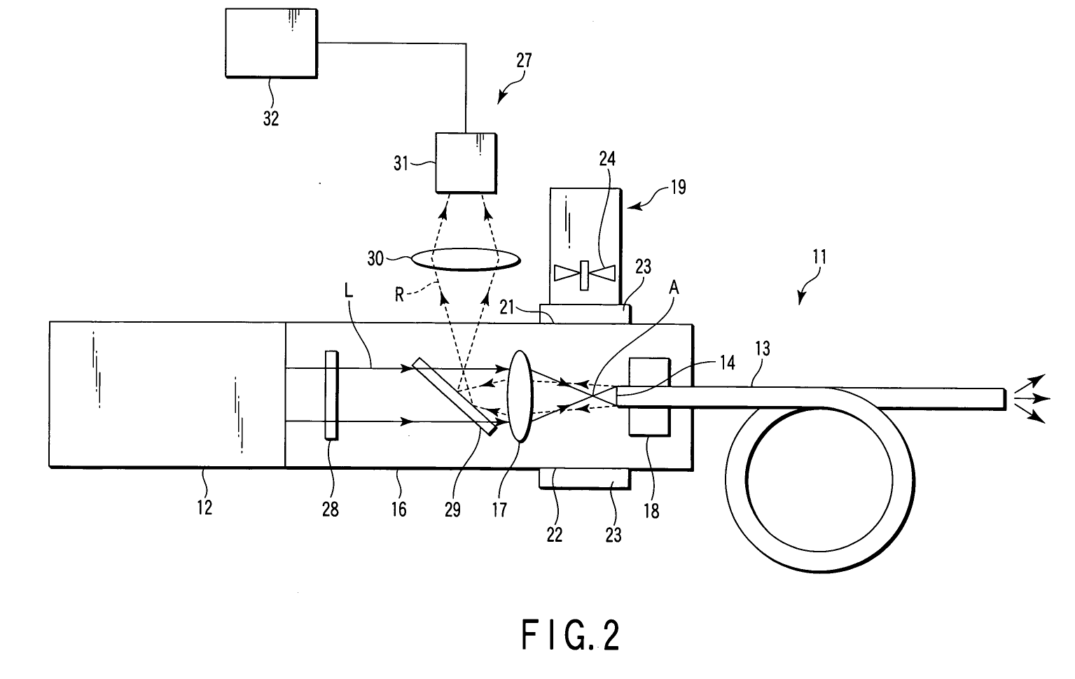

Next, a laser beam injection adjusting device 27 adjusting a position at which the laser beam L is injected into the optical fiber 13, is shown in FIG. 2.

The laser beam injection adjusting device 27 is operated by removing the shielding case 16. An ND filter 28 for adjusting a quantity of incident light, which lowers the laser beam L, and a beam splitter (sampling mirror) 29 serving as a translucent mirror splitting off a reflected laser beam (return laser beam) R reflected on the entrance end face 14 of the optical fiber 13 from the laser beam L going toward the condenser lens 17 from the laser oscillator 12, are disposed between the laser oscillator 12 and the condenser lens 17.

The reflected laser beam R split off by the beam splitter 29 is formed as an image on an acceptance surface of a CCD camera 31 by an imaging lens 30, and a video photographed by the CCD camera 31 is displayed on a monitor 32. The adjustment of a quantity of light to the CCD camera 31 is executed by the ND filter 28.

Then, while the entrance end face 14 of the optical fiber 13 is observed on the monitor 32, the entrance end face 14 of the optical fiber 13 is fitted to the laser beam L by the optical fiber positioning mechanism 18, which adjusts and sets a position at which the laser beam L is injected into the optical fiber 13.

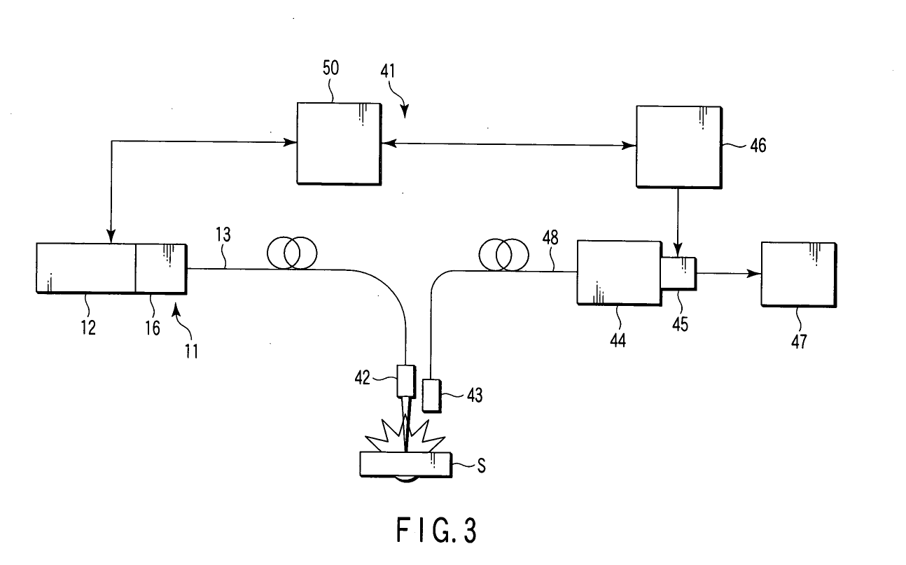

Next, an embodiment in which the laser beam injecting optical device for optical fiber 11 is used for a laser induced fluorescence analyzing apparatus system, will be described in FIG. 3.

A laser induced fluorescence analyzing apparatus 41 has the laser beam injecting optical device for optical fiber 11, an irradiating optical system 42, a fluorescence guiding optical system 43, a spectroscope 44, a CCD camera 45, a timing adjusting mechanism 46, a computer 47 and the like.

The irradiating optical system 42 focuses the laser beam L, injected into the optical fiber 13 by the laser beam injecting optical device for optical fiber 11 and emitted from an exit end face of the optical fiber 13, on a predetermined range of a sample S to be irradiated.

The fluorescence guiding optical system 43 captures fluorescence from the sample S, and injects the captured fluorescence into an optical fiber 48 for guiding it to the subsequent spectroscope 44.

The spectroscope 44 has a wavelength detection range and a wavelength resolving power which are made suitable for the fluorescence property of the sample S by, for example, grating.

The CCD camera 45 receives a light (fluorescence) with a wavelength within a specific range, which is extracted by the spectroscope 44, and outputs an electric signal corresponding to the strength of each light.

The timing adjusting mechanism 46 is a main control device for, for example, a pulse generator or the laser induced fluorescence analyzing apparatus 41, and controls an output timing of a driving pulse supplied to a power supply unit 50 of the laser oscillator 12, an operating timing of the CCD camera 45, and the like, so as to image the fluorescence generated by the sample S in a predetermined timing.

The computer 47 temporarily stores images or spectroscopic spectra output from the CCD camera 45, and analyses the characteristic of the sample S, or processes data as a previous step thereof in accordance with an “element identifying program” or an “element quantification program” stored in advance, or an algorithm for performing predetermined processing on image data and the like supplied from the CCD camera 45.

Then, in the laser induced fluorescence analyzing apparatus 41, the laser oscillator 12 is oscillated in a predetermined timing by the timing adjusting mechanism 46, the laser beam L in a giant-pulse oscillation method, whose peak power is about 1 MW to 25 MW, is injected into the optical fiber 13 whose core diameter is about φ1 mm to be transmitted, and the laser beam L transmitted through the optical fiber 13 is irradiated onto the sample S from the irradiating optical system 42.

When the laser beam L with a diameter of several hundred μm is irradiated onto the sample S by the irradiating optical system 42, the irradiated power density is made several GW/cm² to several dozen GW/cm², and the sample S is instantly transformed into plasma. The respective elements existing in the sample S respectively emit unique fluorescence spectra by receiving the energy of the plasma. The fluorescence spectra are guided into the spectroscope 44 by the fluorescence guiding optical system 43, and the CCD camera 45 measures the spectra. At this time, because the fluorescence spectra emit light in retard by several μsec to several hundred μsec of the plasma emission, a delay and a gate are provided in a measurement time of the CCD camera 45 by the timing adjusting mechanism 46, which makes it possible to measure only necessary fluorescence spectra. Measured results are collected by the computer 47 for data acquisition, and the elements included in the sample S are analyzed.

In this laser induced fluorescence analysis, a pretreatment onto the sample S such as an ICP optical emission spectrometry is almost unnecessary, and a rapid measurement is possible.

At this time, provided that the laser beam L is freely guided to be irradiated onto the sample S, and the apparatus can be made compact, it is possible to carry the apparatus to a site such as a factory, and analysis is possible on the site, which leads to a great advantage.

Because a short pulse laser beam whose peak power is about 1 MW to 25 MW necessary for laser induced fluorescence analysis can be transmitted through the optical fiber 13 whose core diameter is about +φ1 mm by the laser beam injecting optical device for optical fiber 11, it is possible to provide the laser induced fluorescence analyzing apparatus 41 which is compact and capable of freely irradiating the laser beam L onto an measuring object.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A laser beam injecting optical device for optical fiber, comprising:
a shielding case;
a laser oscillator which outputs a laser beam into the shielding case;
a condenser lens which is disposed in the shielding case, and condenses a laser beam output by the laser oscillator;
an optical fiber positioning mechanism which disposes an entrance end face of the optical fiber posterior to a focusing point of the laser beam by the condenser lens in the shielding case, and makes the laser beam diffusive to be injected into the entrance end face of the optical fiber; and
ventilating means for ventilating an ambient gas in the shielding case.

2. The laser beam injecting optical device for optical fiber according to claim 1, wherein the laser oscillator outputs a laser beam in a giant-pulse oscillation method, whose peak power is 1 MW to 25 MW.

3. The laser beam injecting optical device for optical fiber according to claim 1, wherein the ventilating means includes an inlet which guides an ambient gas into the shielding case, an exhaust port which exhausts the ambient gas from the shielding case, and a dustproof filter installed to each of the inlet and the exhaust port.

4. The laser beam injecting optical device for optical fiber according to claim 2, wherein the ventilating means includes an inlet which guides an ambient gas into the shielding case, an exhaust port which exhausts the ambient gas from the shielding case, and a dustproof filter installed to each of the inlet and the exhaust port.

5. The laser beam injecting optical device for optical fiber according to claim 3, wherein the inlet and the exhaust port of the ventilating means face one another with the focusing point of the laser beam by the condenser lens interposed therebetween.

6. The laser beam injecting optical device for optical fiber according to claim 4, wherein the inlet and the exhaust port of the ventilating means face one another with the focusing point of the laser beam by the condenser lens interposed therebetween.
